(19) United States
(12) Patent Application Publication
(10) Pub. No.: US 2013/0140405 A1
(43) Pub. Date: Jun. 6, 2013

(54) Integral Powered Wing Aircraft Utilizing Full Rotary Disc Stacking With Aeronautical Enhancements

(71) Applicant: Waldemar F. Kissel, JR., Gainesville, FL (US)

(72) Inventor: Waldemar F. Kissel, JR., Gainesville, FL (US)

(73) Assignee: WFK & Associates, LLC, Gainesville, FL (US)

(21) Appl. No.: 13/650,576

(22) Filed: Oct. 12, 2012

Related U.S. Application Data
(63) Continuation-in-part of application No. 13/118,509, filed on May 30, 2011.
Application No. 13/118,509 is a continuation-in-part of application No. 12/501,971, filed on Jul. 13, 2009, now Pat. No. 7,950,603.
Application No. 12/501,971 is a division of application No. 11/521,597, filed on Sep. 14, 2006, now Pat. No. 7,559,506.
(60) Provisional application No. 61/546,141, filed on Oct. 12, 2011.
(60) Provisional application No. 60/717,145, filed on Sep. 14, 2005.

(51) Int. Cl. B64D 33/00

(52) U.S. Cl. CPC B64D 33/00
USPC 244/53 R

(57) ABSTRACT

In prior embodiments of the IPWA was configured as concentric contra-rotating discs. In this patent the IPWA is configured as a stack of contra-rotating discs. The top disc may be a single disc, or several concentric discs rotating within one another in the same direction of rotation. There may be one or more discs below the top disc. Each lower disc rotates in the same direction and opposite the rotation of the top disc or discs.

### CROSS REFERENCE TO RELATED APPLICATIONS

This application claims priority to co-pending provisional patent application Ser. No. 61/546,141 filed on Oct. 12, 2011, and entitled “Integral Powered Wing Aircraft Utilizing Full Rotary Disc Stacking with Aeronautical Enhancements.” The contents of this co-pending application are fully incorporated herein for all purposes. This application also claims priority to and is a continuation-in-part of co-pending application Ser. No. 13/118,509 filed on May 30, 2011, and entitled “Integral Powered Winged Aircraft for Infantry and Artillery Mobilization and Front Line Combat”, which in turn claims priority to and is a continuation-in-part of application Ser. No. 12/501,971 filed on Jul. 13, 2009, and entitled “Integral Powered Wing Aircraft” (now U.S. Pat. No. 7,950,603). The '971 application, in turn, is a divisional of and claims priority to application Ser. No. 11/521,597 filed on Sep. 14, 2006, and entitled “Integral Powered Wing Aircraft” (now U.S. Pat. No. 7,559,506). The '597 application, in turn, claims priority to provisional application Ser. No. 60/717,145 filed on Sep. 14, 2005, entitled “Integral Powered Wine Aircraft.” The contents of all the foregoing applications are fully incorporated herein by reference for all purposes.

### BACKGROUND OF THE INVENTION

This application relates to an integral powered wing aircraft (or IPWA). More specifically the present invention relates to an aircraft design consisting of two concentrically oriented contra-rotating discs, whereby rotational forces generated by the discs are equal and in opposition to each other such that a central axis remains fixed. This invention consists of a series of aeronautical performance enhancements that may be applied individually or collectively to the various embodiments described. This patent application will then introduce disc stacking a variation of the prior embodiments, which use individual discs rotating concentrically about a canopy and anchored to a central axle. The contra-rotating discs are stacked one above the other as contrasted with a concentric configuration in prior embodiments. The series of aeronautical enhancements referenced above will then be collectively incorporated in the presentation of the preferred embodiment.

It is an objective of this invention to enhance the performance of prior embodiments by extending the mounting arms of the inner concentric disc out to the outer diameter of the outer concentric disc. The linear synchronized electromagnetic drive motor [LSEDM] lower section is then removed from the outer edge of the inner disc and relocated and attached to the end of these extended mounting arms. The upper section of [LSEDM] that in prior embodiments is mounted to the inner edge of the outer concentric disc is now mounted to the bottom of the outer edge of the outer disc. The LSEDM is now located at the maximum extremity of the circumference of the outer disc thus maximizing the effective torque of the LSEDM about the central axle. The larger LSEDM will create greater force and the longer mounting arm radii will amplify the torque. A larger internal combustion engine [ICE] and electric generator may be provided for even greater performance.

It is an objective of this invention to enhance the prior embodiments performance by providing a vertical rim about the outer circumference of the outer concentric circle. These prior embodiment include the embodiments disclosed in commonly owned U.S. Pat. No. 7,950,603 and U.S. Pat. No. 7,559,506, the contents of which are fully incorporated herein for all purposes. The vertical rim shall extend some distance above the top horizontal plane of the disc so as to obstruct the air flow from the outer edges. The effect is to reduce the average ambient atmospheric pressure above the disc.

It is an objective of this invention to enhance the performance of prior embodiments by providing a vertical rim about the outer circumference of the outer concentric circle. The vertical rim about and extending below the outer circumference of the outer concentric circle shall extend downward for some distance, but at least including the Directional Stabilizer within the rim. This will enhance performance by concentrating the downward air flow to increase the average ambient atmospheric pressure below the contra-rotating discs and canopy from above.

It is an objective of this invention to enhance the performance of prior embodiments by extending short air foil segments out from the outer circumference of the outer disc. This provides additional lift. Placing a rim about the outer loose edge reinforces the foil and adds even more lift.

It is an objective of this invention to enhance performance of prior embodiments by changing the two contra-rotating concentric discs into two discs each having the same outer diameter and approximately the same inner diameter. The two discs are stacked, one above the other, and both contra rotate concentrically about the canopy or core. The LSEDM is mounted between and about the outer edge of the two contra-rotating stacked discs.

It is an objective of this invention to enhance the performance of prior embodiments by adding a thin, short, lightweight skirt about the outer rim of the directional stabilizer. This will allow the contra-rotating discs to force air into the non-rotating skirt which will create a ground effect lift on the IPWA when it is travelling a few inches above water, sand, snow, desert, or similar flat surface.

It is an objective of this invention to enhance the performance of prior embodiments by continuing with objective #5 above and modifying it as follows. The single large disc containing air foils along the radii of its surface is replaced with three concentric discs with total area, radii and circumference approximately equivalent to the one disc they replace. These concentric discs create rows of air foils held in place by rims on each side. The second disc is below the upper disc. The surface of this second disc may be similar to a turbine blade, a fan, a tapered spiral of any appropriate shape. This disc rotates about the axle. An LSEDM around the outer circumference of the largest upper disc and the full lower disc drives the two discs in opposing directions. There is an LSEDM between the inner edge of the outermost disc and the outer edge of the second largest concentric disc. The larger disc drives the second larger disc in the same direction as itself, but at greater rate of revolutions per minute. Similarly there is a LSEDM positioned between the inner edge of the second largest concentric disc and the outer edge of the smallest and innermost concentric disc. The lower disc may have steep angled blades to create a greater rotational resistance and simultaneously increasing the downward push on air flow to the directional stabilizer. The blades become steeper in angle as it gets closer to the center.

It is an objective of this invention to enhance the performance of prior embodiments by continuing with objective #5 above and modifying it as follows. The single large disc contains air foils along the radii of its surface as well as various other contours and configurations to enhance or aid lift. This disc (a) has a single large disc (b) below it and has a LSEDM that drives the contra-rotation of the two discs against one another, as in objective #5, except the upper disc offers greater resistance than the lower disc by itself. It requires more energy to rotate the upper disc than the lower disc. Furthermore, it is understood that when the upper disc reaches maximum velocity, it can create no additional lift from its air foils. So it is desirable to gain additional lift from air below these two discs. So a third disc similar to the second disc is added below disc #2. Then a fourth disc similar to disc #2 is stacked below disc #3. There is a LSEDM between the second and third discs, and the third and fourth disc. However, the second, third, and fourth discs may or may not all be rotating in the same direction. The third may rotate in the opposite direction. The third may rotate at more RPM's than the second. The fourth may rotate at more RPM's than the third.

It is an objective of this invention to enhance the performance of prior embodiments by combining all the enhancements #1 through #8 to create an enhanced preferred embodiment.

### SUMMARY OF THE INVENTION

This invention discloses a number of aeronautical enhancements to the prior embodiments that can be combined in part or collectively to provide enhancements that can be combined in part or collectively to provide an enhancement that is a faster, more powerful, better performing and more efficient aircraft than the prior art. This invention disclosure also introduces an additional preferred embodiment that creates the new concept of disc stacking.

### BRIEF DESCRIPTION OF THE DRAWINGS

FIG. 1 shows the linear synchronized electromagnetic drive motor moved to the outer perimeter of the aircraft.

FIG. 1A is a detailed view taken from FIG. 1.

FIG. 1B is a detailed view taken from FIG. 1

FIG. 1C is a detailed view taken from FIG. 1.

FIG. 2A is a top view of an integral powered winged aircraft.

FIG. 2B is a side view of an integral powered winged aircraft.

FIG. 2C is a bottom view of an integral powered winged aircraft.

FIG. 3A is a top view of an integral powered winged aircraft.

FIG. 3B is a side view of an integral powered winged aircraft.

FIG. 3C is a bottom view of an integral powered winged aircraft.

FIG. 4A is a plurality of short air foil segments are attached to and extending out from the top and/or largest disc perimeter.

FIG. 4B is a side view of the device depicted in FIG. 4A

FIG. 4C is a bottom view of the device depicted in FIG. 4A.

FIG. 5A is a view of an aircraft utilizing concentric contra-rotating discs.

FIG. 5B is a side view of the aircraft depicted in FIG. 5A.

FIG. 5C is a sectional view of another aircraft having upper and lower contra-rotating discs.

FIG. 5D is a further aircraft embodiment utilizing contra-rotating discs.

FIG. 6A is a ground effects skirt is attached to and suspended from the outer rim of the directional/stabilizer.

FIG. 7A is an aircraft embodiment utilizing triple Independent Rotating Concentric Discs.

FIG. 7B is a side elevational view of the aircraft depicted in FIG. 7A.

FIG. 7C is a detailed view of the lower disc in the embodiment of FIG. 7A.

FIG. 7D is a detailed view of a synchronized electromagnetic drive motor used by the aircraft of FIG. 7A.

FIG. 7E is a detailed view of a synchronized electromagnetic drive motor used by the aircraft of FIG. 7A.

FIG. 8A is a top view of a vehicle utilizing a single large disc concentric canopy.

FIG. 8B is a view of a second disc that is employed by the vehicle of FIG. 7A.

FIG. 8C is a view of a vehicle using a stack of discs and a directional/stabilizer.

FIG. 8D is a detailed view of a bearing.

FIG. 9A is a top view of a preferred embodiment of the present disclosure.

FIG. 9B is a side view of a preferred embodiment of the present disclosure.

FIG. 10 is a top view of a circular truss diagram.

### DETAILED DESCRIPTION OF THE INVENTION

The present invention relates to an integral powered winged aircraft or “IPWA”. More specifically, the invention relates to an aircraft wherein lift is generated by two discs which rotate about a central axis. The discs generate equal and opposite forces such that the central axis remains fixed, thereby allowing it to be used for a crew or cargo compartment. In one embodiment, the two discs are concentrically located. The various components of the present invention, and the manner in which they interrelate, will be described in greater detail hereinafter.

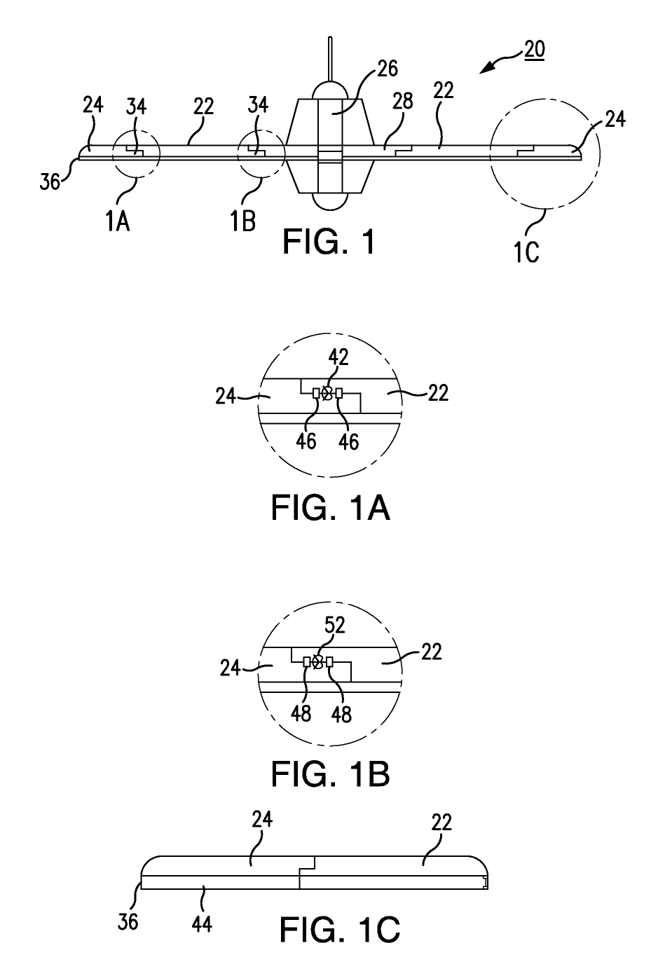

FIG. 1 is a cross section of a IPWA 20, which includes inner and outer rotating discs 22 and 24. The non-rotating central axle 26 is attached to the non-rotating canopy 28. The bearing 32 rotates about axle 26 and supports the mounting arms 34 attached to both the inner and outer edges of inner disc 32. The outer ends of the mounting arm are connected by a rim 36 in FIG. 1C. Rim 36 makes a complete circle around the outer perimeter of the mounting arms 34 and provides structural support for the lower section 38 of the linear synchronized electromagnetic drive motor (“LSEDM”). In FIG. 1A 34 LSEDM 42 is located between the inner edge of the outer disc 24, and the outer edge of the inner disc 22, is relocated, as shown in FIG. 1C to the outer perimeter of the outer disc 24. The upper section of LSEDM 42 is mounted to the bottom of the outer disc 24. The lower section of LSEDM 38 is mounted to the top of the structural rim 36 that is attached to the extended mounting arms 44 that are attached to the inner disc 22. In FIG. 1A the bearings 46 remain as in the prior embodiments. In FIG. 1B the bearings 48 of LSEDM 42 between the inner edge of the inner disc 22 and canopy 28 remain as in the prior embodiments (i.e. U.S. Pat. Nos. 7,950,603 and 7,559,506). These bearings are what transfer lift from the outer and inner discs 22 and 24 to the canopy 28 and central axle 26.

Placing the LSEDM 42 at the outer edge of this larger radius increases the torque arm of the LSEDM and thus the speed and lift of the vehicle 20, even if LSEDM 42 simply continues to exert the same force between the upper and lower sections of the LSEDM because the discs will be rotating faster with the same level of power input.

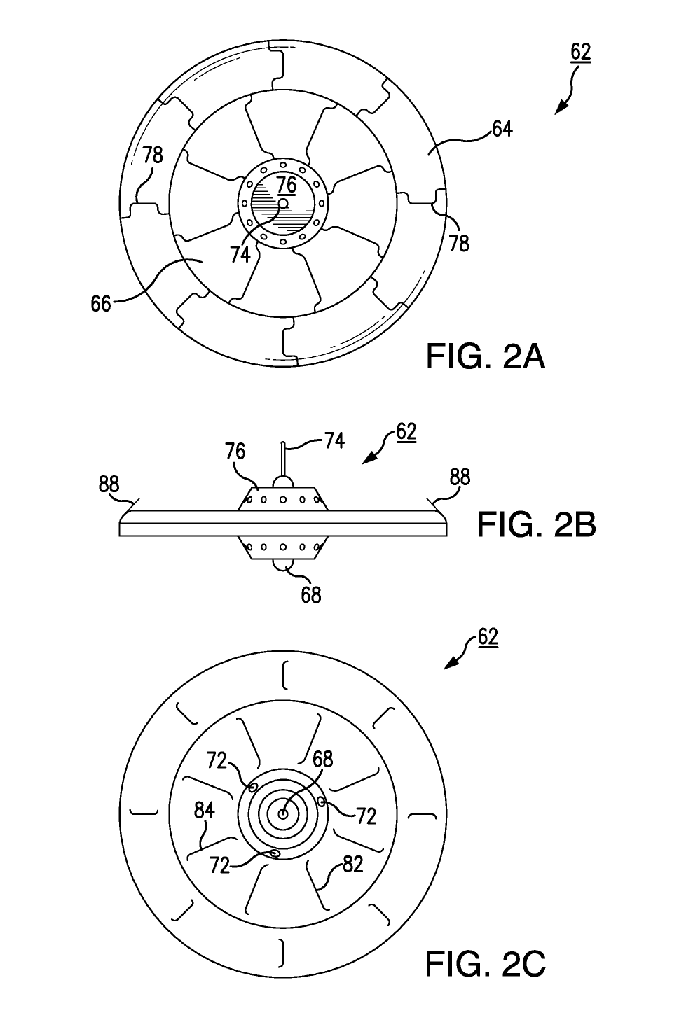

FIGS. 2A-C illustrate the top, side, and bottom views of another IPWA 62. It has outer disc 64, inner disc 66, landing gear 68, ground sensors 72, antenna 74, canopy 76 air foil air inlets 78, air diverters 82 and 94. A vertical rim 86 is attached around the outer rim of the perimeter of the outer disc 64. This rim 88 extends some unspecified distance above the top plain of the outer disc 64. The height of rim 88 will be determined by design criteria for a specific vehicle. The effect of 88 is to obstruct air from the side areas outside the perimeter of disc 64 from flowing in and over the top of the disc thereby reducing the air foil lift and partially equalizing the average ambient reduced air pressure above the disc with that of normal atmospheric pressure.

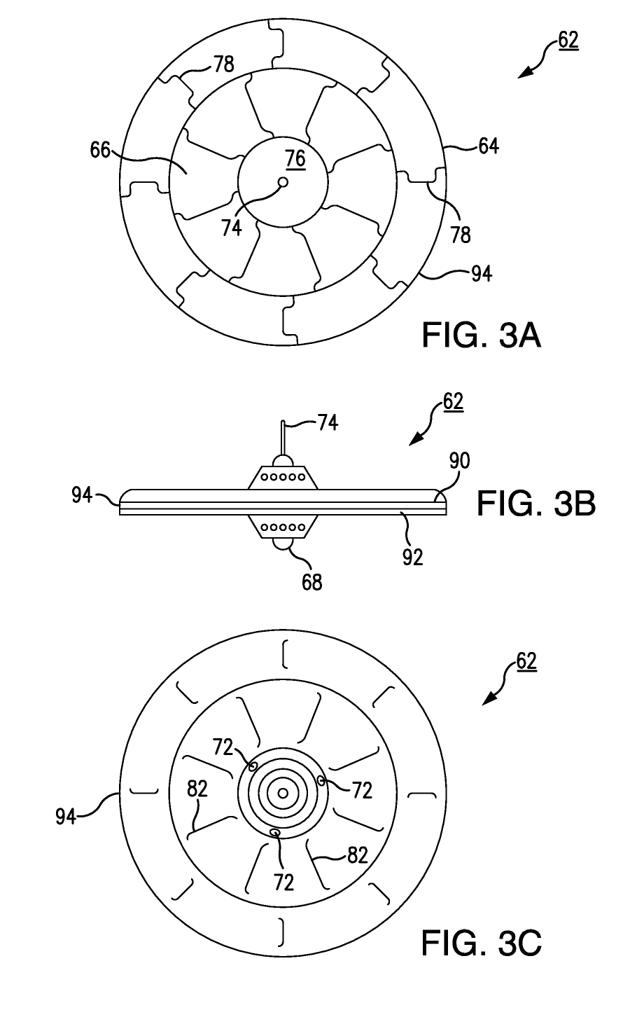

FIGS. 3A-C illustrate the top, side, and bottom view of a typical IPWA vehicles. The vehicle component letter designations remain the same as in FIG. 2. The directional/stabilizer is identified by the 92. A vertical lower vertical rim 94 is attached to the lower edge 90 at the perimeter of outer disc 64. This lower rim 94 extends some unspecified distance below the bottom of the outer disc that shall, at a minimum, include further than the bottom of the bottom plain of the directional stabilizer. This lower rim 94 will enhance performance by preventing air flow disbursement and concentrating the downward flowing air from the discs above to increase the average ambient atmospheric pressure below the discs and canopy above.

The upper rim 88 described in FIG. 2B and lower rim 94 described in FIG. 3B will enhance the pressure differential (lift) between the areas above and below the discs.

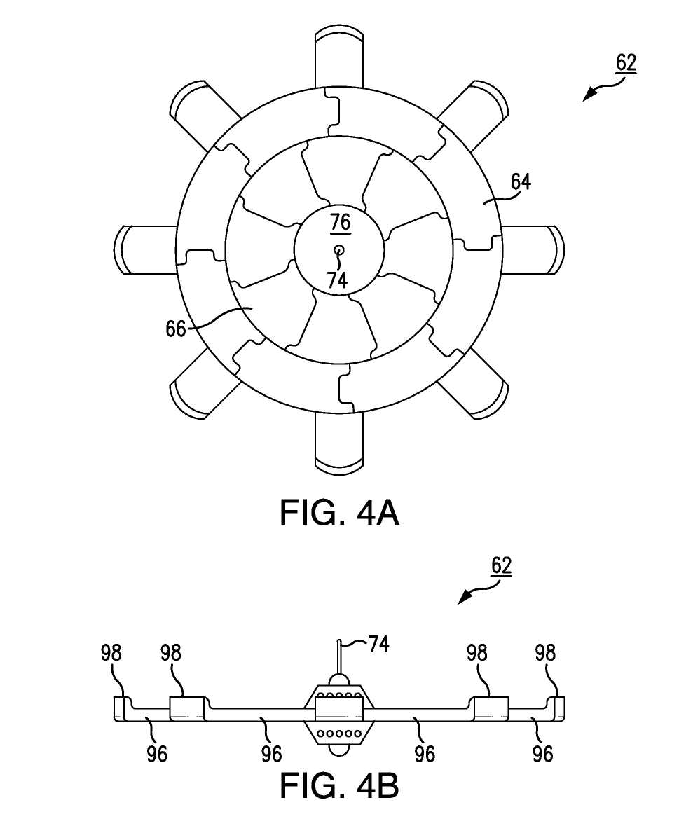

FIGS. 4A-C illustrate the top, side and bottom view of IPWA 62. The vehicle component letter designations remain the same as in FIG. 2 and FIG. 3.

FIG. 4 shows air foils 96 extended outward from the outer perimeter of the outermost disc. The length of the air foil and the quantity of such air foils is determined by design preferences. The tip 98 of these air foils is turned up on the end to further enhance the lifting capacity of the air foil extensions. The air foil extensions 96 with turned up tips 98 add lifting capacity to the basic aircraft.

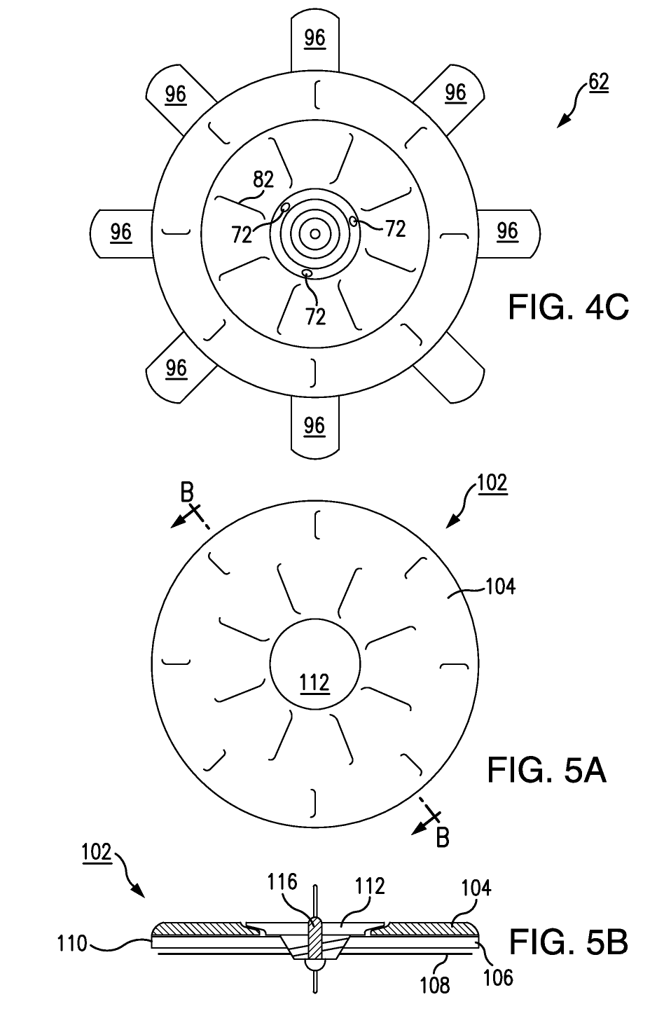

FIG. 5 illustrates concentric contra-rotating discs of aircraft 102. Aircraft 102 includes a disc stack consisting of a single disc 104 on top and one or more single discs 106 on bottom, with a directional/stabilizer 108 located below the stack. The upper disc and lower disc are driven in opposite directions by the LSEDM 110 located between the two discs just inside the outer perimeter of the two discs. The upper disc 104 is concentric to the canopy 112 but has mounting arms that connect it to bearings 114 rotating about the central axle 116. The lower disc 106 has mounting arms connecting it to bearings 114 rotating about the central axle 116. The upper disc has air foils, air inlets, contours and other aeronautic features as shown and described above. The lower disc 106 is receiving air that is being thrust downward from the upper disc 104. Air foils serve no purpose on lower disc 106. Lower disc 106 is like a turbine or fan blade to accelerate air to travel down with greater velocity.

FIG. 5C is a section view illustrating another vehicle 120 having upper and lower contra-rotating discs (104 and 106) driven by a pair of internal combustion engines 118 in place of the LSEDM shown in other embodiments. A large axle 122 forms the backbone of vehicle 120. It has an attached canopy 124. Upper disc 126 is attached by mounting arms 128 to upper bearing 132 which has an upper bearing extended sleeve 134 that traverses below the similar components of the lower discs. The extended sleeve 134 has gear teeth about its perimeter driven by drive gear 136 to rotate the upper disc. The drive gear 136 is attached to a gear box 138 attached to an internal combustion engine 118.

A lower disc 142 is attached by mounting arms 144 to lower bearing 146 and extended sleeve 148 which both wrap over and around the upper bearing extended sleeve 134. The extended sleeve 148 has gear teeth 152 about its perimeter. These gear teeth 152 are driven in the opposite direction by drive gear 154 attached to gear box 156 powered by internal combustion engine 118. The lower disc 142 is rotated in the opposite direction of the upper disc 126. There are numerous ways to configure these disc motors.

Whenever the contra rotating discs, as illustrated in FIG. 5C are driven by internal combustion engines, electric motors, or any kind of source of power that drives out from the central axle and bearings it is necessary to deliver a substantial torque through the mounting arms.

When the torque is being created by an LSEDM at the outer circumference of a disc there is only a radial load on the mounting arms. The torque coming back to the bearings is minimal because any unbalanced torque is relieved by rotation of the bearings around the axle.

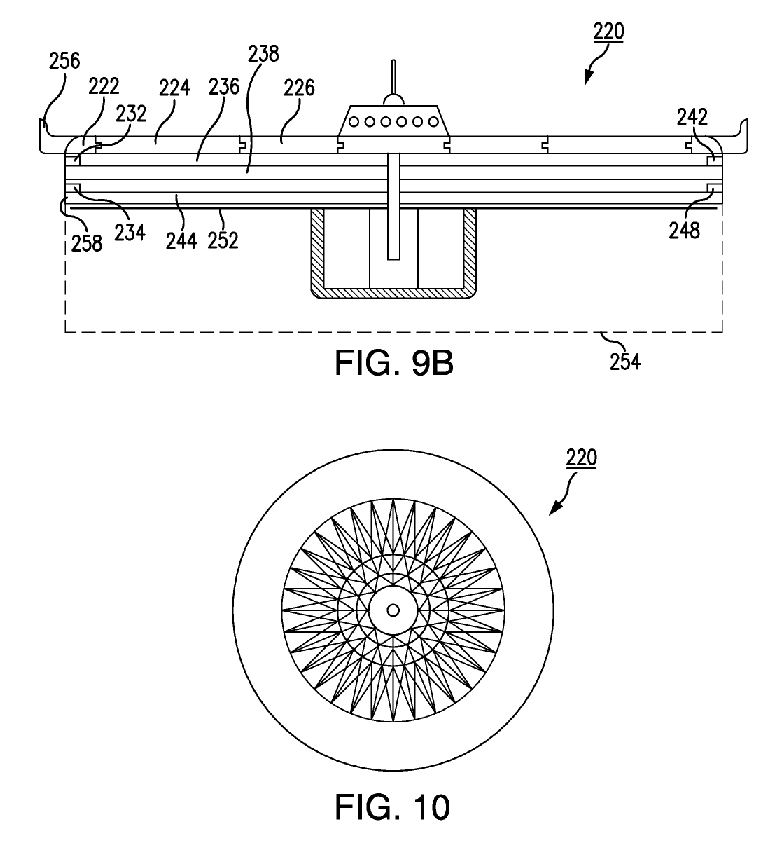

So when the torque to drive the discs is being transferred through the mounting arms then the mounting arms need circumferential and rotational bracing as shown in the Circular Truss Diagram claim in FIG. 10. This illustrates a single plane mounting arm lattice that allows transfer of torque from the axle bearings out to each individual disc. This is a lightweight, but powerful configuration.

FIG. 5D illustrates a basic small IPWA embodiment that may be just a couple or three feet in diameter. It may be used for surveillance applications. An internal combustion motor 118 drives a gear box 138 that operates contra-rotating motors that rotate lower discs 142 and upper disc 126 in opposite directions. There is no canopy. An antenna 74 is at the tip of the rotor. The body 162 and 164 of the drive motor and gear assembly are attached to the directional/stabilizer 166 and a camera 168 is mounted below. The upper disc 126 has a rim 172 that comes down below the lower disc and directional/stabilizer for concentrating air flow.

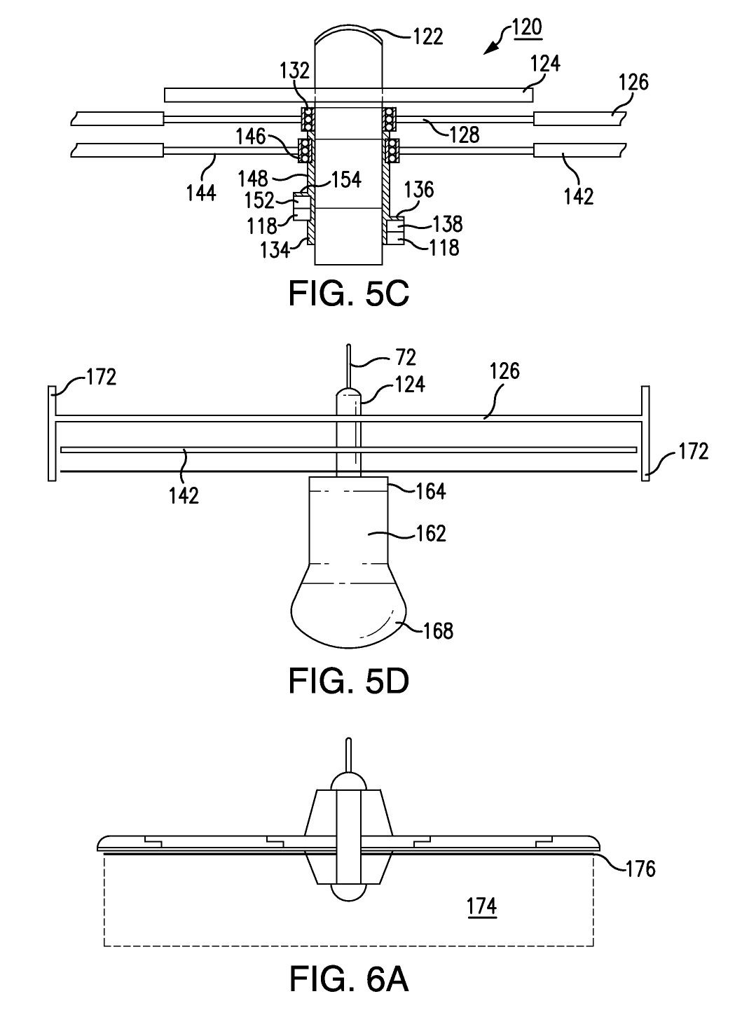

In FIG. 6A a lightweight skirt 174 has been attached to the outer rim 176 of the directional/stabilizer. The purpose of the skirt is to cause the IPWA to gain some of the characteristics of a hovercraft when the vehicle is traveling close to the ground level while traveling over smooth surfaces such as water, sand, snow, ice or desert.

With the skirt in place the IPWA should be able to travel faster than if it were traveling in water, but consume less energy than it would traveling several feet above ground. The directional/stabilizer would still be used to control the vehicle movements.

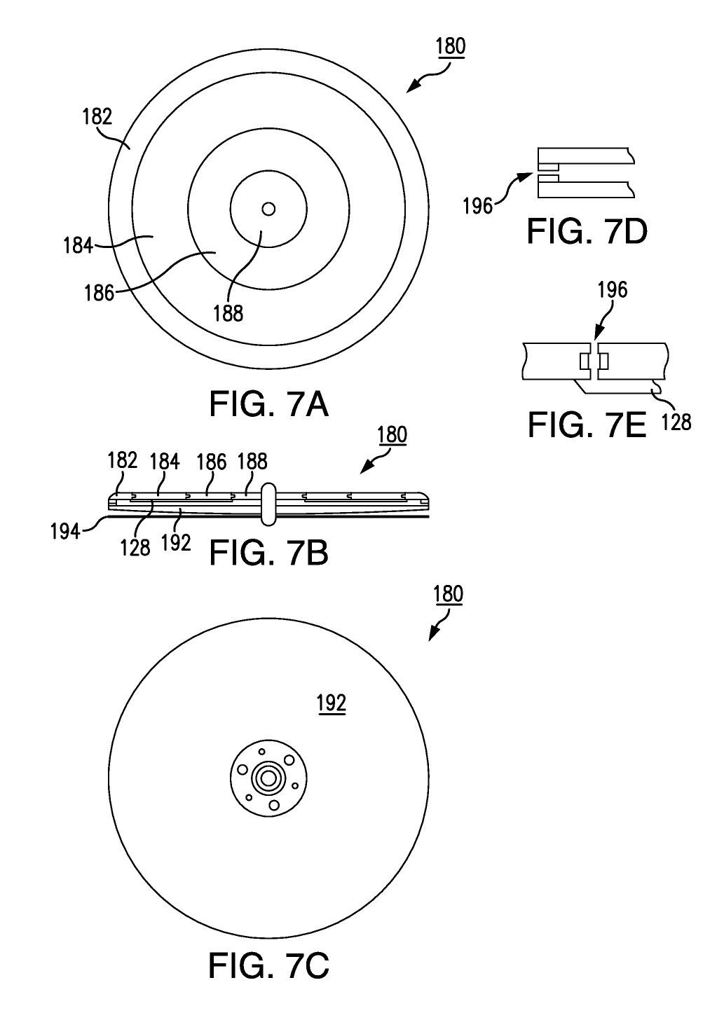

FIG. 7A top view shows an additional vehicle 180, three concentric discs, an outer disc 182, a middle disc 184, and an inner disc 186. All discs rotate in the same plane and direction about a canopy 188. A lower single disc 192 is located in a plane below discs 182, 184 and 186.

Discs 182, 184 and 186 rotate outside and inside one another. Their surfaces are a series of air foils or any combination of contours and configurations that will create and enhance the lifting capacity of these discs. The surface of the lower disc 192 shall be similar to a turbine blade, a fan, a tapered spiral, or any configuration that will increase lift by forcing down the air it receives from the discs above it. The lower disc 192 may be two or more discs driven in the same or opposite rotational direction. A directional/stabilizer 194 is located below the lowest rotating disc 192 and can be attached back to the central axle.

Outer disc 182 has an LSEDM 196 attached between the outer rim of lower disc 192. These discs exert equal and opposite forces against one another to create the counter rotation.

An LSEDM 196 is located between the inner rim of disc 182 and the outer rim of disc 184. Disc 184 is driven in the same direction as disc 182 but at a greater speed of rotation.

An LSEDM 196 is also located between the inner rim of disc 184 and the outer rim of disc 186. Disc 186 rotates in the same direction as disc 184 but at a greater speed of rotation.

Each disc has its own set of mounting arms back to the central axle and each disc receives its own electric current flow from its own mounting arms.

There are bearings 198 between the inner rim of disc 186 and the outer rim of the canopy 188.

The maximum revolutions per minute that disc 182 may rotate is limited as the outer rim approaches the speed of sound. However if disc 184 was rotating at the same speed as disc 182, it would not be reaching this upper limit. This allows the LSEDM 196 to drive disc 184 faster until the outer rim of disc 184 approaches the speed of sound. Next, an LSEDM 196 between disc 184 and disc 186 accelerates the rotation of disc 186 until the outer rim of disc 186 approaches the speed of sound. With all three disc rotating at maximum RPM in the same direction of rotation maximum lift can be achieved, provided enough energy is available. This is one of two major advantages of partitioning one large top disc into two or more concentric discs that can rotate independently. It is understood that an alternative to the LSEDM is to have one or more motors or drive trains at the axle that drives each of the mounting arms in the appropriate direction and speed. The motor can be an internal combustion engine, electric motor or any type of drive motor.

There is a second major purpose for changing one large disc into two or more concentric discs. When the large disc is rotating near maximum RPM the radial g forces are enormous. They can easily exceed 1000 g's. By partitioning the one large disc into multiple discs the length of the airfoil and radial length of the disc is decreased. This decreases the g forces in each of the narrower concentric discs. If a concentric disc is simply a thin inner narrow band and a thin outer narrow band with airfoils attached between them then each airfoil will be in tension (tensile stress) where it is attached to the inner band and in compression (compressive stress) where it is attached to the outer band. Somewhere near the middle of each airfoil there would be a place where there is neither tensile stress nor compression forces. Creating multiple concentric discs makes it much easier (and allows a lighter vehicle) to control these radial forces.

The lower disc has the same maximum rotational limits as the upper disc. It is for this reason that an additional 1, 2, or more similar turbine like discs may be necessary below the lower disc 192 just so the lower discs collectively can counter for the collective momentum of the three concentric upper level rotating discs.

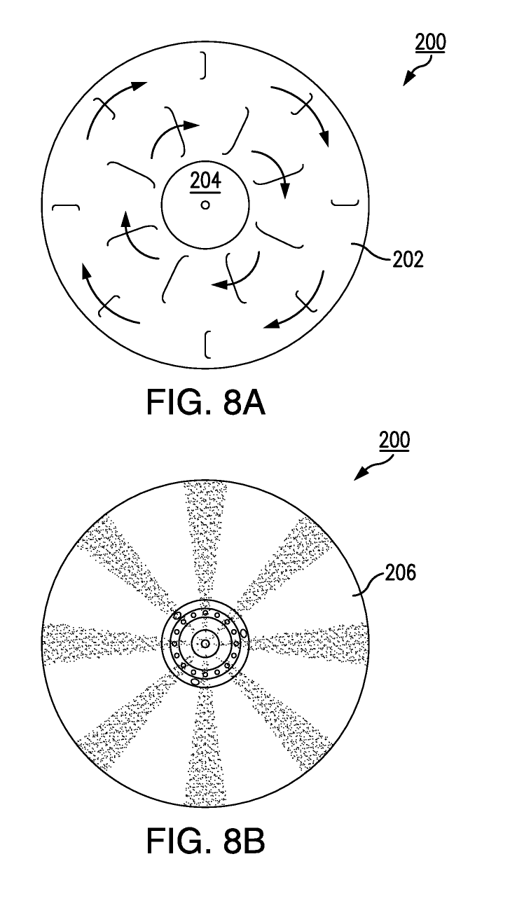

In FIG. 8A top view is shown a vehicle 200 with a single large disc concentric to canopy 204. This disc contains numerous air foils along the radii of its surface as well as various other contours and configurations to enhance the lifting capacity of the disc. A second disc 206 FIG. 8B is located below disc 202. Disc 206 has fan, turbine or spiral blades that force air down. The two discs are driven against each other by an LSEDM located between the outer edge of disc 202 and the outer edge of disc 206. However, because of the air foils, it will require more force to rotate upper disc 202 than lower disc 206. To create a better equilibrium a third disc (c) and fourth disc (d) are added as necessary. A directional/stabilizer 212 is below this stack shown in FIG. 8C.

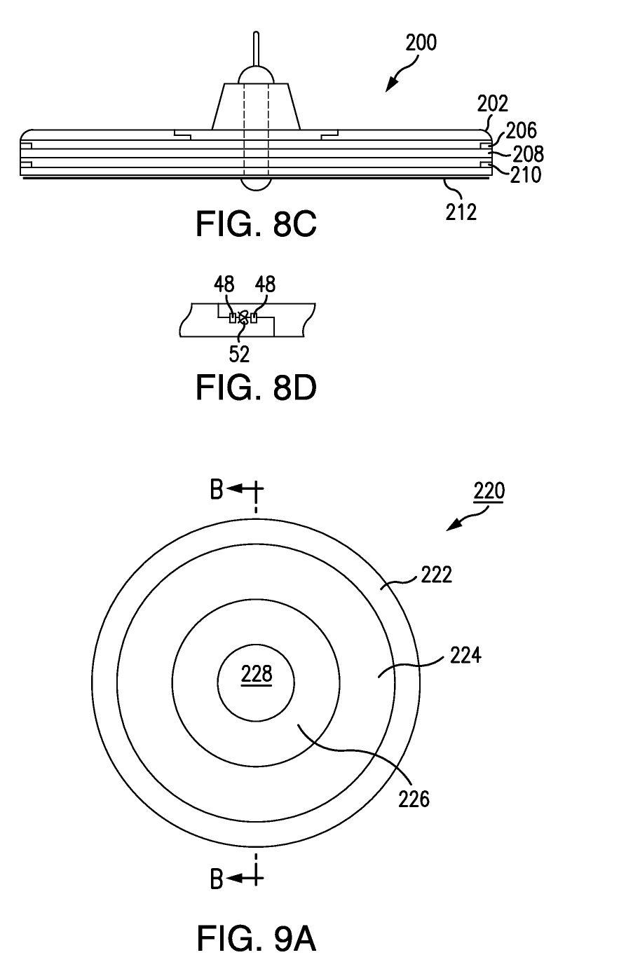

FIG. 9 combines all the enhancements into one complete preferred embodiment 220. Disc 222 is the outer disc, disc 224 is the middle disc, disc 226 is the inner disc and 228 is the non-rotating stationary disc. LSEDM 232 drives disc 224 from disc 222, LSEDM 234 drives disc 226 from disc 224, disc 226 rotates faster disc 224, disc 224 rotates faster than disc 222. An LSEDM 232 is located between outer rim of outer disc 222 and first lower disc 236. The next lower disc 238 is driven by LSEDM 242 off of disc 236 or it can be driven off the inside of the inverted trim ring 244. The lowest disc, or bottom disc 246 is driven by LSEDM 248 off of 238 or the inverted trim ring 244. The directional/stabilizer 252 is located below the lowest disc. The hovercraft skirt 254 extends some distance down off the rim of the directional/stabilizer. The vertical outer rim 256 extends above the top of the plain of the upper discs 222, 224, 226 and 228 to prevent air from bleeding off the outer edges of the outer disc. Disc 222, rim 256, and 258 all rotate as one unit. The skirt 254 does not rotate. Each of discs 222, 224 and 226 consist of inner and outer rims that support the plurality of air foils on each disc. It is understood that discs 222, 224 and 226 could be replaced with a singular upper disc. While the preferred embodiment in FIG. 9 illustrates most of the enhancements disclosed herein it is understood the various enhancements can be used in part or in any combination to create a variety of embodiments for any specific configured application embodiment.

What is claimed is:

1. An aircraft, comprising:
a central axle, comprising a top end and a bottom end;
a stationary passenger canopy associated with the central axle;
a first disc having an inner and an outer periphery, a first mounting arm associated with the inner periphery, the first mounting arm rotatably mounting the first disc to the stationary passenger canopy;
a second disc having an inner and an outer periphery, a second mounting arm associated with the inner periphery, the second mounting arm rotatably mounting the second disc to the outer periphery of the first disc;
a first linear synchronous electromagnetic drive motor associated with the first mounting arm for rotating the first disc with respect to the stationary passenger canopy;
a second linear synchronous electromagnetic drive motor associated with the second mounting arm for rotating the second disc with respect to the first disc;
an extended mounting arm mounted below the second disc, a third linear synchronous electromagnetic drive motor mounted between the extended mounting arm and the outer periphery of the second disc, wherein the third linear synchronous electromagnetic drive motor further drives the second disc.

2. An aircraft, comprising:
a central axle, comprising a top end and a bottom end;
a first disc having an inner and an outer periphery, a first mounting arm associated with the inner periphery, the first mounting arm rotatably mounting the first disc about the central axle;
a second disc having an inner and an outer periphery, a second mounting arm associated with the inner periphery, the second mounting arm rotatably mounting the second disc to the outer periphery of the first disc;
a first motor associated with the first mounting arm for rotating the first disc with respect to the central axle;
a second motor associated with the second mounting arm for rotating the second disc with respect to the first disc.

3. The aircraft as described in claim 2 further comprising an extended mounting arm mounted below the second disc, a third motor mounted between the extended mounting arm and the outer periphery of the second disc, wherein the third motor further drives the second disc.

4. The aircraft as described in claim 2 wherein the motors are liner synchronous electromagnetic drive motors.

5. The aircraft as described in claim 2 further comprising a plurality of airfoil segments that extend radially from the second disc.

6. The aircraft as described in claim 5 wherein each of the airfoil segments has an outer edge that is turned up.

7. The aircraft as described in claim 2 wherein the first and second discs are concentrically arranged.

8. The aircraft as described in claim 2 wherein the first disc is positioned above the second disc.

9. The aircraft as described in claim 2 wherein a skirt extends downwardly from the outer periphery of the second disc.

10. An aircraft, comprising:
a central axle, comprising a top end and a bottom end;
a first and second contra rotating discs, each of the discs having inner and outer peripheries, bearings positioned along the inner periphery of each disc to thereby allow the discs to rotate relative to each other;
electric motors associated with each of the bearing for powering the rotation of the first and second discs.
